(19) United States
(12) Patent Application Publication
(10) Pub. No.: US 2007/0050388 A1
(43) Pub. Date: Mar. 1, 2007

(54) Device and method for text stream mining

(75) Inventor: Nathaniel G. Martin, Rochester, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/211,194

(22) Filed: Aug. 25, 2005

(51) Int. Cl. G06F 7/00

(52) U.S. Cl. 707/101

(57) ABSTRACT

A method and system for categorizing text clusters a stream of text into clusters. A subject matter expert explores the clusters using a rule based analysis module by creating one or more rules or synonyms.

### BACKGROUND

Data mining is the extraction of useful knowledge from a data source that was collected for a purpose other than the mere extraction of knowledge. For example, credit card data is collected to create accurate customer bills, but this data source also contains data about consumer spending habits that may be valuable to retailers. Thus, credit card companies have mined consumer credit card data to identify data that can help the company and its affiliates and partners direct advertising and promotions that are individualized to the consumer.

Data stream mining is the application of data mining to a stream of data, such as that which may be generated by a set of sensors or another potentially limitless stream of data. Challenges in data stream mining include, among other items, keeping up with the data and generating accurate conclusions from the limited amount of data than can be processed together.

Text mining is a type of data mining that involves extracting data and/or knowledge from a set of text statements. To analyze the text, text is generally converted to numerical or categorical data against which data mining methods can be applied. As used in this document, “text” or a “text statement” may refer to any combination of alphanumeric characters. It may also include punctuation marks, database records and/or symbols that have a meaningful relationship to each other. Accordingly, text stream mining is the application of data mining to a stream of text, such as a service log, e-mail system, voicemail system, or other system that receives and/or passes messages.

The various forms of data mining described above are extremely important in government and commercial environments. The ability of an organization to quickly and efficiently manage, sort, understand, and identify important data points in large volumes of data can directly result in substantial cost savings—or cost increases, depending whether the organization's ability is good, fair or poor.

For example, in a field service environment, such as that where a technician must communicate with a home base either during or after a service call, a log of text messages, voice messages, or recorded phone conversations may be kept and stored for future reference and/or archival purposes. The messages may be viewed by future technicians, as a service event may include multiple communications between different field service personnel and central service personnel.

Many service events and other activities require experience and an understanding of past real world events, and problem-solving abilities can be improved if there were a way to increase the experience and understanding of multiple individuals.

The present disclosure describes methods and systems that solve one or more of the problems listed above.

### SUMMARY

In accordance with one embodiment, a system for categorizing text includes a clustering module, a rule-based analysis module, and a categorization module. The clustering module clusters a stream of text into clusters, and a subject matter expert explores the clusters using the rule based analysis module by creating one or more rules or synonyms.

The clustering module may create a set of initial rules for the rule based analysis module, and it may also accept the rules or synonyms to alter the clustering. The categorization module may run in parallel with the clustering and rule based analysis modules so that the clustering and rule-based analysis modules operate on a sample of the stream of text.

In accordance with an alternate embodiment, a method for improving message categorization includes receiving a set of clustered messages from a clustering module, and applying, optionally by a subject matter expert, one or more rules or synonyms to the clustered messages to determine whether the clustering may be improved. If the applying determines that the clustering may be improved, the method the clustering system may be notified of one or more improvements to include in re-clustering. If the applying determines that the clustering is satisfactory, the clustered messages may be delivered to a categorization module for categorization training.

Optionally, if the applying determines that the clustering may be improved, the method may also include receiving re-clustered messages from the clustering system and applying one or more rules to the re-clustered messages to determine whether the clustering may be further improved. The improvements may include, for example, a text fragment inclusion or exclusion rule, a cluster labeling rule, or a rule that references a synonym set. The clustering system may also produce a set of default clustering considerations, and the clustering system may assign improvements received from the notifying action a greater weight than at least one of the default clustering consideration. Optionally, the clustered messages may have been selected from a stream of messages supplied to the categorization system.

In accordance with an alternate embodiment, a text stream mining system includes a clustering module, an analysis module, and a categorization module. The analysis module receives clustered messages from the clustering module, applies one or more rules or synonyms to the clustered messages, and delivers a training set of clustered documents to the categorization module. Optionally, the analysis module provides an output that enables a user to determine whether to deliver one or more of the applied rules to the clustering module. The rules may include, for example, a header and text fragment, and a message satisfies the rule if the message includes some or all of the text fragment. In an embodiment, the categorization module may categorize messages from a first message stream, and the clustering module may cluster messages from a second message stream. The messages from the second message stream may be a subset of the messages from the first message stream.

In accordance with an alternate embodiment, a computer-readable carrier contains program instructions that instruct a computer to receive clustered messages, apply a rule to the clustered messages, and indicate which of the clustered messages satisfy the rule. If a subject matter expert determines that the rule or synonym will improve a clustering process, the instructions may instruct the computer to send a clustering improvement to a clustering module and receive re-clustered messages that were clustered using the clustering improvement. If a subject matter expert determines that the clustered messages are appropriately clustered, the instructions may instruct the computer to identify the clustered messages as a training set for categorization training.

### BRIEF DESCRIPTION OF THE DRAWINGS

FIG. 1 illustrates exemplary components of a text stream mining system in block diagram form.

FIG. 2 illustrates an exemplary text analysis system input

FIG. 3 illustrates an exemplary text analysis system output.

FIG. 4 is a flowchart of an exemplary text stream mining process.

FIG. 5 illustrates exemplary features of a computer system.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “document” or “message” is a reference to one or more communication events such as documents, text messages, instant messages, electronic mail, real-time conversations, voice messages, and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

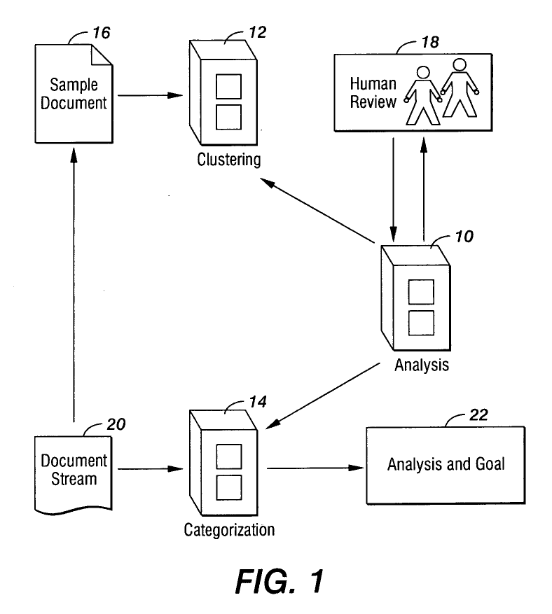

In an embodiment, referring to FIG. 1, a data mining system may include a text analysis module 10, a clustering module 12, and a categorization module 14. The modules may be in the form of computer program code running on, implemented by or accessed through multiple computers or other electronic devices that are in communication with each other via a communications network such as a local area network, wide area network, the Internet or any other type of communication system, including but not limited to those presently in existence. Alternatively, two of the modules or all of the modules may be present in a single computer or other electronic device.

A set of sample messages 16, which may include any raw text stream such as a stream of documents, text messages, instant messages, electronic mail, real-time conversations, voice messages, database records and other communications are received by clustering module 12. Optionally, the messages may be transformed into an appropriate electronic form for analysis by clustering module 12.

Clustering module 12 may group messages (i.e., objects) into clusters based on similarity metrics. Any clustering technology may be used. For example, clustering module 12 may treat the text as a bag of words, that is, a set of unique words appearing in the text along with the number of times that word appears in the document. In this example, the number of occurrences of the words may be treated as a vector with the word itself providing the index into the vector. The clustering algorithm may thus search for sets of vectors that are close to each other in an n-dimensional space defined by the indices of the vectors, but distant from other clusters of vectors in the same space. The n-dimensional space may be a Euclidian space, probability space or other type of space generated specifically for the application. However, the current embodiments are not limited to bag of words-type clustering.

Accordingly, clustering module 12 may use any suitable clustering algorithm to perform its function. For example, “k-means” clustering may be used to assign objects to k different clusters. As is known in the art, k-means clustering is a partitioning method that usually begins with k randomly selected objects as cluster centers. Objects are assigned to the closest cluster center (i.e., the center they have the highest similarity with), and cluster centers are recomputed as the mean of their members. The process of (re)assignment of objects and re-computation of means is repeated several times until it converges. The number k of clusters is a parameter of the method. Exemplary values of k may be about 20 or about 50, but other values may be used to based on the user's preferences. Examples of k-means clustering methods are described in U.S. Pat. No. 6,598,054 Schuetze et al. which is incorporated by reference in its entirety. In particular, FIG. 9 of Schuetze et al. and its accompanying text describe a clustering method that uses a waveform algorithm.

Alternatively, clustering module 12 may be configured to perform soft hierarchical clustering of objects, such as textual documents that each include a plurality of words. There are several ways soft hierarchical clustering may be performed, such as using maximum likelihood and a deterministic variant of the Expectation-Maximization (EM) algorithm. Exemplary techniques are described in U.S. Patent Application Pub. No. 2003/0101187, filed by Gaussier et al., which is incorporated herein by reference in its entirety. Alternatively, hierarchical multi-modal clustering can also be used.

Regardless of the clustering technology, the similarities used to create the clusters may or may not be the similarities desired. A technique is desired that will allow the subject matter experts who will use the results of the text stream mining to indicate the aspects of the text they are interested in. This may be done by passing the results of the clustering module 12 (i.e., an identification of documents that are clustered) to analysis module 10 for further processing by subject matter experts. The clustering results may also be passed to one or more reviewers 18 using the analysis module in an attempt to improve the clustering results. The reviewer or reviewers may include, for example, a service provider, the customer who is requesting the clustering, or another reviewer. The review may be performed manually and/or by machine analysis using clustering algorithms that differ from those included in the clustering module 12.

Analysis module 10 may coexist with the clustering module 12, or it may be separate from the clustering module so that a user, such as a subject matter expert, may use the analysis module 10 to validate the results of the clustering. Validation does not necessarily require a guarantee of accuracy, but rather involves an exploration of the clusters and documents contained in the clusters by the reviewers creating and applying a set of rules to the documents and cluster terms to analyze the cluster terms in the context of a document. Based on the output of the analysis module 10, the user may then provide feedback to the clustering module 12 and/or other human reviewer 18 along with the document set and clustering results so that the clustering module 10 can improve the clustering results. The feedback can be provided to either the clustering module 12 in the form of a clustering improvement or another human reviewer 18 because the rules that capture the reviewers re-clustering may be captured in rules that can be read either by a machine or another human. The clustering improvement or feedback may include, for example a group of words that are relevant to a cluster, or one or more words that are irrelevant to the cluster, a synonym set or a cluster label.

Analysis module 10 may be a computer-implemented, rules-based analysis module that applies rules to text and produces a result that helps a human or machine reviewer perform an analysis of the application of rules to the text. Suitable analysis techniques include those described in, for example, U.S. patent application Ser. No. 11/088,513, filed Mar. 24, 2005, the disclosure of which is incorporated herein by reference in its entirety. In such an exemplary technique, a human subject matter expert (SME) (i.e., someone having knowledge of the technical, business or other field to which the documents relate) may use the analysis module to analyze textual data to be mined from the clustering results. The clustering results may include text fragments or “snippets” from a document, entire documents, or both. The SME may receive the clustering results and identify, select or create a set of rules to be applied to the results. The rules may include, for example, a “head” and a “tail”, where the head includes a cluster or category and the tail includes the set of terms that must appear in a document in order for the document to be assigned that category. The rules may also include one or more synonym sets that will trigger a rule when a synonym is found in the clustering results. The analysis module 10 will then apply the rules to the text to see which text snippets may satisfy the rule. The SME can then review the results and compare them to the actual messages or portions of messages to determine whether the rules are appropriate for clustering messages.

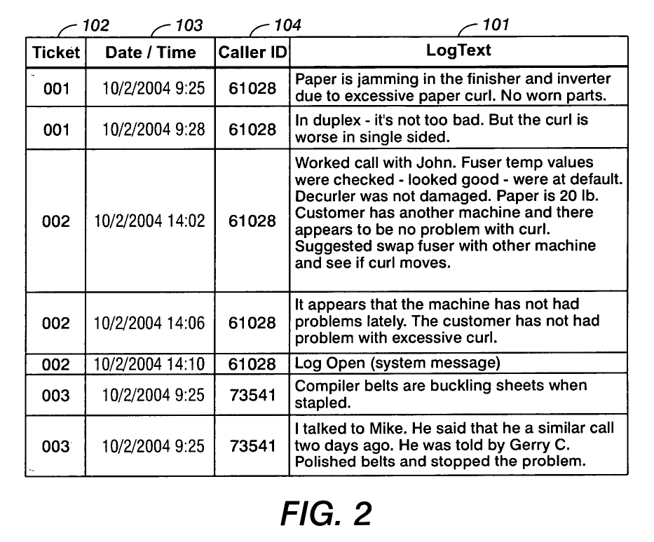

For example, referring to FIG. 2, a group of clustered messages may be received by an analysis module and placed into an appropriate format for analysis, such as a spreadsheet format. The messages may include message text, as illustrated by the column labeled “LogText” 101 and additional information such as a job or ticket identifier 102, a message date and/or time 103, and an identifier 104 corresponding to the caller or message generator. The column labels are merely exemplary, and each of the additional information columns may be considered to be optional.

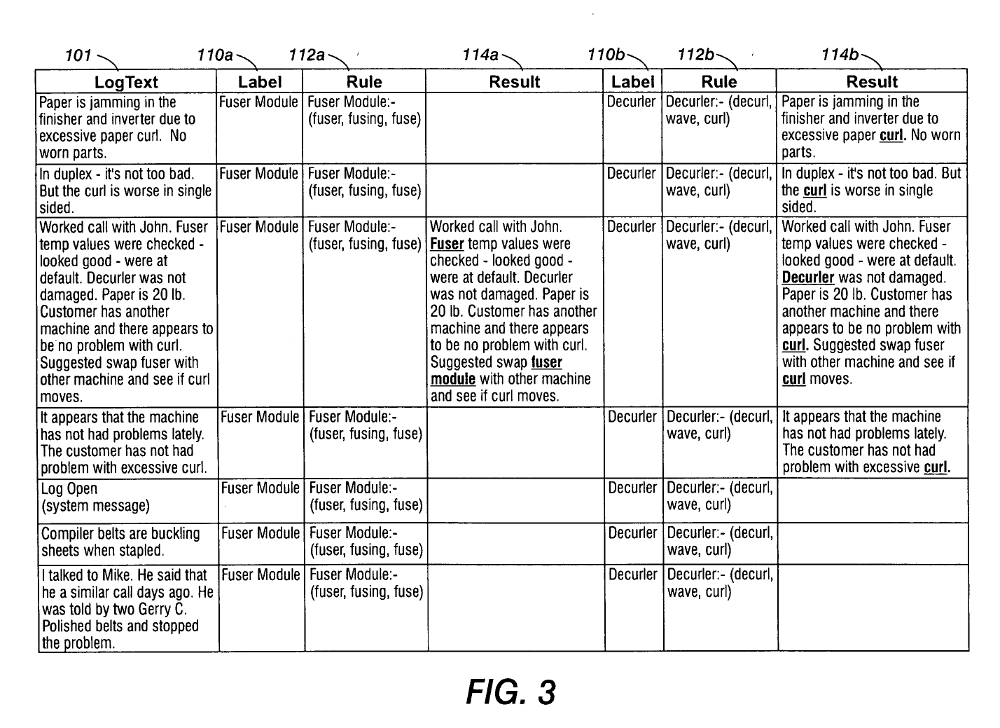

Referring to FIG. 3, a user, such as a SME, may apply one or more rules 112a, 112b to the messages and receive a report indicative of messages that receive a label 110a, 110b indicating that they satisfy the rules. One exemplary rule illustrated in FIG. 3 is to give a text segment the label “Fuser Module” if it contains any of the words in the {fuser, fusing, fuse} set 112a. Another exemplary rule is give a text segment the label “Decurler” if it contains any of the words in the {decurl, wave, curl} set 112b. Alternatively, the rule could apply the label to any message containing a specified number of words in the set, such as two or more words or all words. Thus, with the exemplary rules shown in FIG. 3, the SME may explore which messages relate to fuser modules, decurlers, or both. The report may include, for example, a number of messages that satisfy the rule, a number of messages that fail to satisfy the rule, and/or an indication of highlighted terms within the messages 114a, 114b. In addition, the SME may explore whether one or more rules or rule labels may be improved by referring to a synonym set so that words having similar or related meanings are clustered. Note that the word “synonym” as used herein is not limited to words having exactly or substantially the same meaning, but rather to any terms that are related, in the view of the SME or other user, in a manner that may help the SME analyze the clustering results.

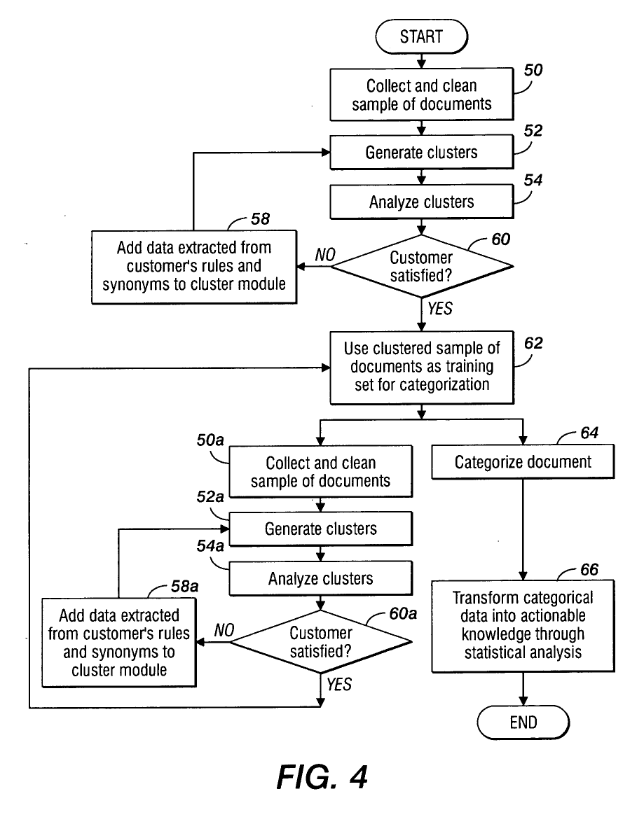

Returning to FIG. 1, if, after the work of the analysis module 10 is complete, the clustering results are inadequate in the view of the SME, the results can be returned to the clustering module 12 with or in the form of feedback with one or more rules for improving the clustering process. Optionally, if a human reviewer 18 was also involved, feedback in the form of rules or other feedback may be provided to the reviewer. In an embodiment, the feedback may be in the form of rules, such as “cluster documents containing term A and term B”, or “cluster documents containing term X and term Y but not term Z.” Other rules may include synonyms, such as “consider term D to be synonymous with term E.” Rules may also include rules for labeling, such as “label a cluster with terms X and Y as ‘cluster Q’”. Thus, the rules can be used by the clustering module 10 and/or reviewer 18 to improve the clustering results. As an example, referring to FIG. 4, if the SME sees that the clustering results include three messages unrelated to fuser modules and curling, two of which instead appear to related to belt systems, the SME may deliver an omission rule to the clustering module to request that the clustering module exclude phrases containing the word “belt” unless they also include “fuser module”, “decurler”, or a synonym.

Returning again to FIG. 1, in an embodiment, the clustering module 12 may weight the rules received as a result of the analysis module's 10 work differently from that of other rules. For example, clustering module 12 may contain a default rule set, but when a customer provides a new rule in the form of feedback, that rule may be given greater weight than some or all rules in the default rule set.

After the SME determines through analysis module 10 that the clustering is adequate, the results of the clustering may be passed to the categorization module 14. Categorization module may use the clustered documents as a training set to learn how to categorize future documents 20, such as text streams, to yield categorized data for further analysis 22 using any desired statistical or decision support tools. Such tools can transform the categorized data into actionable knowledge.

Optionally, after the categorization module 14 has received its initial training as described above, the training may be updated and/or improved by repeating the processes of the clustering module 12 and analysis module 10 on an additional sample set of documents. In an embodiment, the sample sets are taken from the document stream 20, and the process of clustering new sample sets may be repeated on a periodic basis.

In an exemplary application of a text stream mining system, a machine maintenance group, such as that having personnel that install, maintain and/or repair xerographic equipment, may include field service personnel and base personnel. The field service personnel may identify problems while on the job, and they may communicate with the base personnel to identify possible solutions to the problems. Through trial and error, the field service personnel may find that some of the possible solutions better than others, and these findings may be included in the communications back and forth between the field service personnel and the base personnel. The communications may occur in real time, while the service occurs, or it may be in the form of a post service report.

Such communications may occur for multiple jobsites on a daily basis. As these communications continues to stream in to the base personnel, they may contain a wealth of knowledge that could benefit future field service personnel on future service calls. An initial group of messages may therefore be processed by a clustering module to group them into document clusters. The clustering results may be analyzed by a third party service provider and processed by a rules-based analysis module to identify one or more rules that can improve the clustering. Such rules may include, for example, “do not cluster documents merely because they each contain the word ‘paper’”. Or they may include, for example, “cluster documents containing the terms ‘burn’and ‘wire’” under the label “power system failure.”

FIG. 4 illustrates aspects of a text stream mining process in flowchart form. Referring to FIG. 4, a sample of documents may be collected 50 and clustered 52 using one or more clustering algorithms. The clusters may be analyzed by an SME or other service provider or user 54 to determine whether to apply rules to the clustering system in order to improve the clustering results. The analysis may be a computer-assisted analysis to help the user understand or determine whether the clustering results are satisfactory. If the customer or other user is not satisfied with the clustering results 60, the rules (such as clustering rules, labeling rules and/or synonym sets) may be returned to the clustering system. If the customer or user is satisfied with the clustering results 60, the results may be delivered 62 to a categorization system as a training set for categorization of future documents 64. Such categorized documents may be analyzed for transformation into actionable knowledge through statistical and/or other analysis 66. Optionally, while the categorization is occurring, some or all of steps 52 through 60 may be repeated for one or more additional sample document sets so that the categorization can be improved with additional training sets.

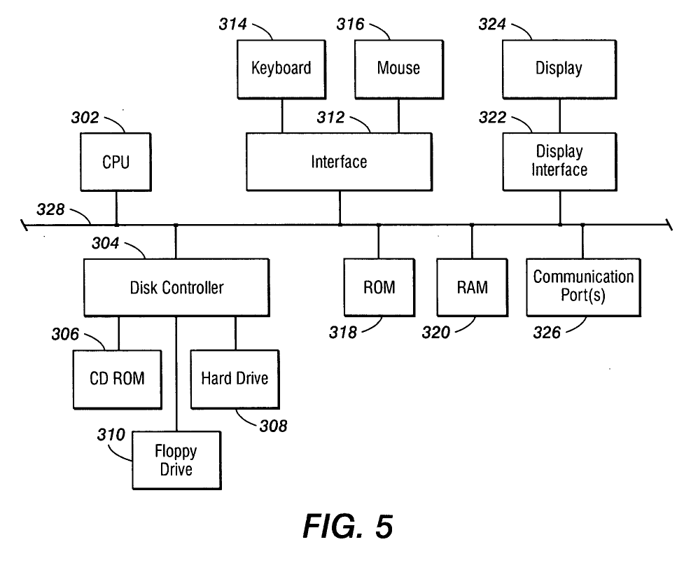

FIG. 5 is a block diagram of exemplary hardware that may be used to contain and/or implement the program instructions of a system embodiment. Of course, any electronic device capable of carrying out instructions contained on a carrier such a memory, signal, or other device capable of holding or storing program instructions may be within the scope described herein. Referring to FIG. 5, a bus 328 serves as the main information highway interconnecting the other illustrated components of the hardware. CPU 302 is a central processing unit of the system, performing calculations and logic operations required to execute a program. Read only memory (ROM) 318 and random access memory (RAM) 320 constitute exemplary memory devices.

A disk controller 304 may interface with one or more optional disk drives to the system bus 328. These disk drives may be external or internal memory keys, zip drives, flash memory devices, floppy disk drives or other memory media such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a computer readable medium such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to the standard computer-type components, the hardware may also include an interface 312 which allows for receipt of data from input devices such as a keyboard 314 or other input device 316 such as a remote control, pointer and/or joystick. A display including touch-screen capability may also be an input device 316. An exemplary touch-screen display is disclosed in U.S. Pat. No. 4,821,029 to Logan et al., which is incorporated herein by reference in its entirety.

An embedded system may optionally be used to perform one, some or all of the operations of the methods described. Likewise, a multiprocessor system may optionally be used to perform one, some or all of the methods described.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for categorizing text comprising:
a clustering module;
a rule-based analysis module; and
a categorization module;
wherein the clustering module clusters a stream of text into clusters, and a subject matter expert explores the clusters using the rule based analysis module by creating one or more rules or synonyms.

2. The system of claim 1, wherein the clustering module creates a set of initial rules for the rule based analysis module.

3. The system of claim 1, wherein the clustering module accepts the one or more rules or synonyms to alter the clustering.

4. The system of claim 1, wherein the categorization module runs in parallel with the clustering module and the rule-based analysis module so that the clustering module and the rule-based analysis module operate on a sample of the stream of text.

5. A method for improving message categorization, comprising:
receiving a set of clustered messages from a clustering module;
applying one or more rules or synonyms to the clustered messages to determine whether the clustering may be improved;
if the applying determines that the clustering may be improved, notifying the clustering system of one or more improvements to include in re-clustering; and
if the applying determines that the clustering is satisfactory, delivering the clustered messages to a categorization module for categorization training.

6. The method of claim 5, wherein if the applying determines that the clustering may be improved, the method also includes:
receiving re-clustered messages from the clustering system; and
applying one or more rules to the re-clustered messages to determine whether the clustering may be further improved.

7. The method of claim 5 wherein the one or more improvements comprise a text fragment inclusion or exclusion rule.

8. The method of claim 5 wherein the one or more improvements comprise a cluster labeling rule.

9. The method of claim 5 wherein the one or more improvements comprise a rule that references a synonym set.

10. The method of claim 5 wherein the clustering system produces a set of default clustering considerations, and the clustering system assigns improvements received from the notifying action a greater weight than at least one of the default clustering considerations.

11. The method of claim 5 wherein the clustering system is improved by one or more of the items.

12. The method of claim 5 wherein the applied one or more rules or synonyms are selected by a human subject matter expert.

13. The method of claim 5, wherein the clustered messages have been selected from a stream of messages supplied to the categorization system.

14. A text stream mining system, comprising:
a clustering module;
an analysis module; and
a categorization module;
wherein the analysis module receives clustered messages from the clustering module, applies one or more rules or synonyms to the clustered messages, and delivers a training set of clustered documents to the categorization module.

15. The system of claim 14, wherein the analysis module provides an output that enables a user to determine whether to deliver one or more of the applied rules to the clustering module.

16. The system of claim 14, wherein the rules comprise a header and text fragment, and a message satisfies the rule if the message includes the text fragment.

17. The system of claim 14, wherein;
the categorization module categorizes messages from a first message stream;
the clustering module clusters messages from a second message stream; and
the messages from the second message stream are a subset of the messages from the first message stream.

18. A computer-readable carrier containing program instructions that instruct a computer to:
receive a plurality of clustered messages;
apply a rule to the clustered messages;
indicate which of the clustered messages satisfy the rule;
if a subject matter expert determines that the rule or synonym will improve a clustering process, send a clustering improvement to a clustering module and receive re-clustered messages that were clustered using the clustering improvement; and
if a subject matter expert determines that the clustered messages are appropriately clustered, identifying the clustered messages as a training set for categorization training.

19. The carrier of claim 18, wherein the clustering improvement comprises a text fragment inclusion or exclusion rule.

20. The carrier of claim 18, wherein the clustering improvement comprises a cluster labeling rule.

21. The carrier of claim 18, wherein the clustering improvement comprises a set of synonyms.
